(19) United States
(12) Patent Application Publication
(10) Pub. No.: US 2015/0342826 A1
(43) Pub. Date: Dec. 3, 2015

(54) VIBRATING MASSAGE APPARATUS AND A BLUETOOTH HEADSET

(71) Applicant: CHI-MOU CHAO, Zhubei City (TW)

(72) Inventor: CHI-MOU CHAO, Zhubei City (TW)

(21) Appl. No.: 14/464,688

(22) Filed: Aug. 20, 2014

(30) Foreign Application Priority Data
May 28, 2014 (TW) 103118530

(51) Int. Cl. A61H 23/02; H04R 1/10

(52) U.S. Cl. CPC A61H 23/0263; H04R 1/1091

(57) ABSTRACT

A vibrating massage apparatus comprises a control device and at least one vibrating device. The control device comprises a waveform generator module for outputting a control signal having a waveform, and a motor drive for receiving the control signal. The at least one vibrating device comprises a housing, a vibrator and a patch. The vibrator is disposed in the housing and is electrically connected to the motor drive, wherein the motor drive controls the vibrator to vibrate in correspondence with the waveform according to the control signal. The patch has one side pasted on one surface of the housing, and the other side pasted on a skin surface.

### BACKGROUND OF THE INVENTION

1. Field of the Invention

The invention relates to a massage apparatus and a Bluetooth headset, and more particularly to a vibrating massage apparatus and a Bluetooth headset, which can be easily carried.

2. Related Art

According to the existing art, a massage apparatus, which can be easily carried, performs a massage by way of current control. As shown in FIG. 1, a low frequency massager 1 utilizes electrode patches 12 to apply a low frequency weak current to directly function on a human body to stimulate muscles or nerves to ease or release pain. The low frequency massager 1 usually comprises a low frequency device 10 and at least two electrode patches 12 connected to the low frequency device 10 through transmission cables 11. Thus, after the user pastes the electrode patches 12 on the to-be-massaged portion or ached portion of the body, the low frequency device 10 can be operated to control the electrode patches 12 to operate in a predetermined functioning mode (e.g., a specific current, voltage and changing frequency) to achieve the massage effect according to the principle. Also, a low frequency controller for controlling the functioning mode of the electrode patch 12 according to the users operation command is usually disposed in the low frequency device 10.

However, using the current to stimulate the muscles to contract causes muscle shrinkage according to the existing art.

In order to improve the drawback of the current-type massage apparatus, a mechanical massager may be used. However, the mechanical massager is large in size and cannot be easily carried, and the users hand has to continuously press the mechanical massager against the ached portion or to fix the mechanical massager at the predetermined portion to massage the muscles and the ached portion. In addition to the inconvenience of carrying the massager, the use of the massager is also considerably inconvenient.

### SUMMARY OF THE INVENTION

An object of an embodiment of the invention is to provide a vibrating massage apparatus to be pasted on a skin surface. The vibrating massage apparatus comprises a control device and at least one vibrating device. The control device comprises a waveform generator module for outputting a control signal having a waveform; and a motor drive for receiving the control signal. The at least one vibrating device comprises a housing, a vibrator and a patch. The vibrator is disposed in the housing and electrically connected to the motor drive, wherein the motor drive controls the vibrator to vibrate in correspondence with the waveform according to the control signal. The patch has one side pasted on one surface of the housing, and the other side pasted on the skin surface.

In one embodiment, the vibrator comprises a motor and an eccentric wheel, and the eccentric wheel is connected to a motor shaft of the motor. When the motor rotates, a particle of the eccentric wheel is not disposed on an axis of the motor shaft, so that the motor is in a state where equilibrium continuously losses, and vibration is caused by inertia.

In one embodiment, a long axis direction of the motor shaft of the motor is parallel to a surface of the patch. Preferably, a lower side of the motor is in contact with a lower surface of an inner wall of the housing to enhance a vibration transmission effect.

In one embodiment, the housing comprises an upper casing, a lower casing and a socket. The lower casing and the upper casing are combined together to form a chamber for accommodating the vibrator within the combined lower and upper casings, and to form a limit structure on an outer side of the combined lower and upper casings. The socket has a lower surface to be attached to the patch, and at least one hook portion for hooking the limit structure.

In one embodiment, the waveform generator module comprises a first waveform generator, a second waveform generator and a multiplexer. The first waveform generator generates the waveform having a predetermined waveform, and outputs the control signal having the predetermined waveform. The second waveform generator receives an audio signal, generates the waveform corresponding to the audio signal according to at least one of rhythm and volume of the audio signal, and outputs the control signal having the waveform corresponding to the audio signal. The multiplexer outputs the control signal of the first waveform generator or the second waveform generator according to a selection signal.

In one embodiment, the second waveform generator comprises an analog-to-digital converter and a digital signal processor. The analog-to-digital converter receives the audio signal and converts the audio signal into a digital audio signal. The digital signal processor receives the digital audio signal and generates the control signal having the waveform corresponding to the audio signal.

In one embodiment, the second waveform generator comprises a wireless receiver and a digital signal processor. The wireless receiver receives the audio signal through radio waves. The digital signal processor receives the audio signal and generates the control signal having the waveform corresponding to the audio signal.

In one embodiment, the vibrating massage apparatus further comprises a signal output line connected to and between the control device and the at least one vibrating device.

In one embodiment, the control device is disposed in the housing of the at least one vibrating device.

Another object of another embodiment of the invention is to provide a Bluetooth headset for broadcasting an audio signal. The Bluetooth headset comprises the vibrating massage apparatus and a wireless receiver. The wireless receiver receives the audio signal through radio waves, and outputs the audio signal to an audio output terminal. The waveform generator module generates the waveform corresponding to the audio signal according to at least one of rhythm and volume of the audio signal, and outputs the control signal having the waveform corresponding to the audio signal.

According to the embodiment of the invention, a vibrating massage apparatus that can be easily carried is provided. The vibrating massage apparatus of the invention is small in size and can be easily carried, so that the problem of the poor vibration effect or the poor vibration transmission effect caused by the small size can be overcome. Furthermore, because the characteristic of the patch can continuously make the vibrator closely rest against the skin surface, the trouble that the user needs to continuously hold the mechanical massage apparatus by the hand can be avoided. In addition, compared with the conventional current-type massager, the invention can avoid the problem of the muscle shrinkage and the problem that the massager cannot be used for a long time.

### BRIEF DESCRIPTION OF THE DRAWINGS

FIG. 1 is a schematic view showing a conventional portable massage apparatus.

FIG. 2 is a schematic view showing a vibrating massage apparatus according to an embodiment of the invention.

FIG. 3A is a top view showing an internal structure of a vibrating device of a vibrating massage apparatus according to an embodiment of the invention.

FIG. 3B is a cross-sectional view showing a side of a vibrating device of a vibrating massage apparatus according to an embodiment of the invention.

FIG. 3C is an exploded view showing a housing of the embodiment of FIG. 3B.

FIG. 4 is a functional block diagram showing a control device according to an embodiment of the invention.

FIG. 5 is a functional block diagram showing a Bluetooth headset having the vibrating massage apparatus according to an embodiment of the invention.

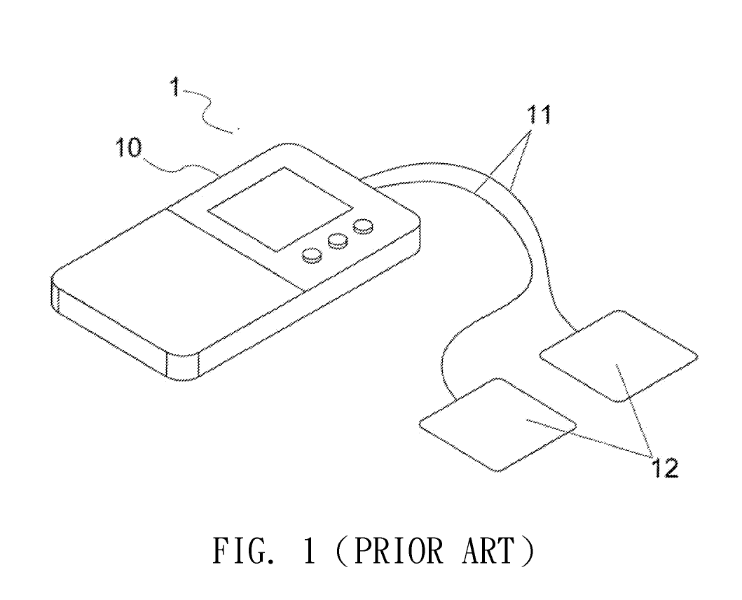

### DETAILED DESCRIPTION OF THE INVENTION

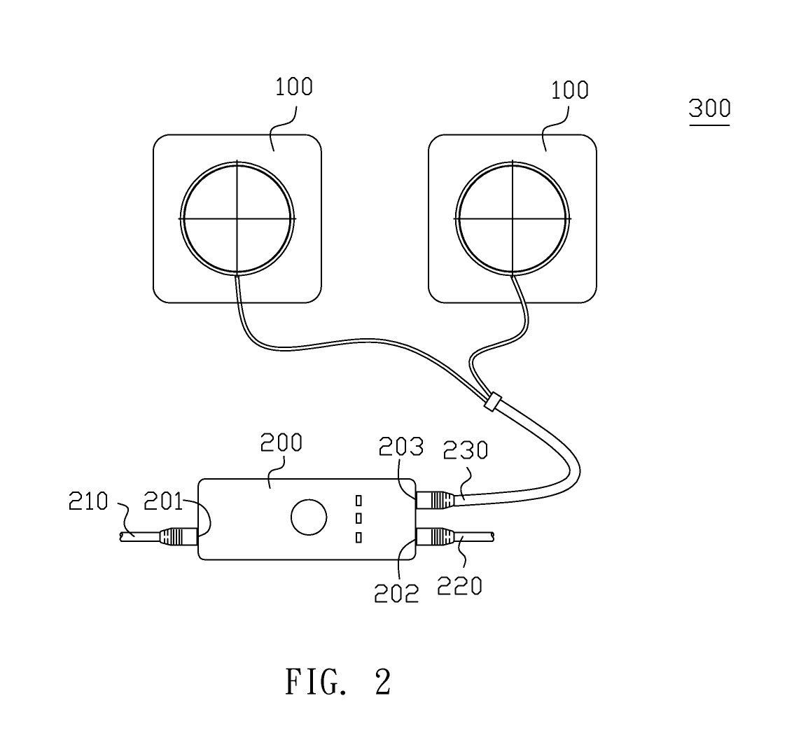

According to an embodiment of the invention, a vibrating massage apparatus 300, which is advantageously easily carried, is provided. FIG. 2 is a schematic view showing the vibrating massage apparatus according to an embodiment of the invention. Referring to FIG. 2, the vibrating massage apparatus 300 comprises a control device 200 and at least one vibrating device 100. In this invention, there are two vibrating devices 100. In one embodiment, the control device 200 may have an audio input terminal 201, an audio output terminal 202 and a signal output terminal 203. The audio input terminal 201, into which an audio is inputted, is connected to an audio cable 210. The audio output terminal 202 is connected to an audio cable 220 of a microphone or a speaker (not shown) so that the audio is broadcasted through the microphone or the speaker. The signal output terminal 203 is connected to the at least one vibrating device 100 through a signal output line 230, and the control device 200 is adapted for outputting the control signal to the vibrating device 100 through the signal output line 230, and the vibrating device 100 vibrates according to the control signal.

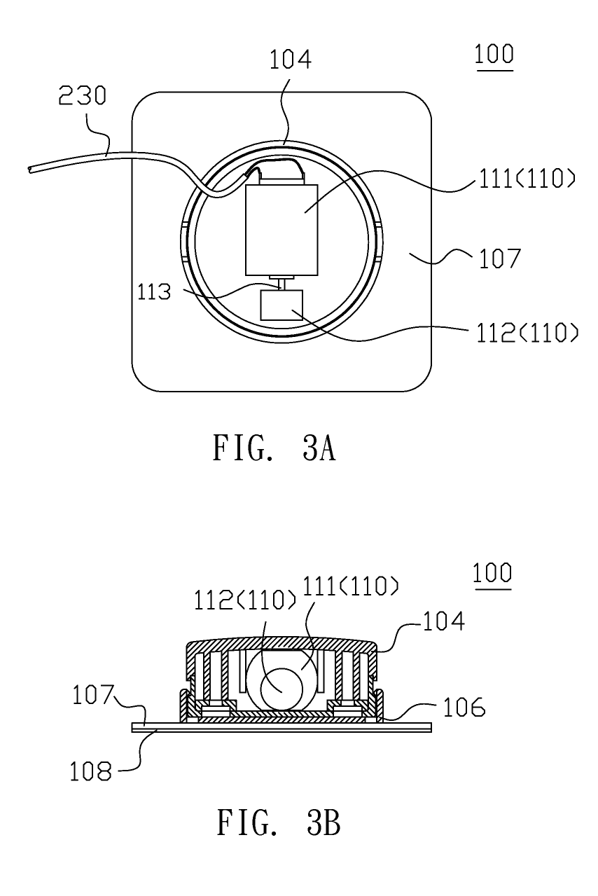

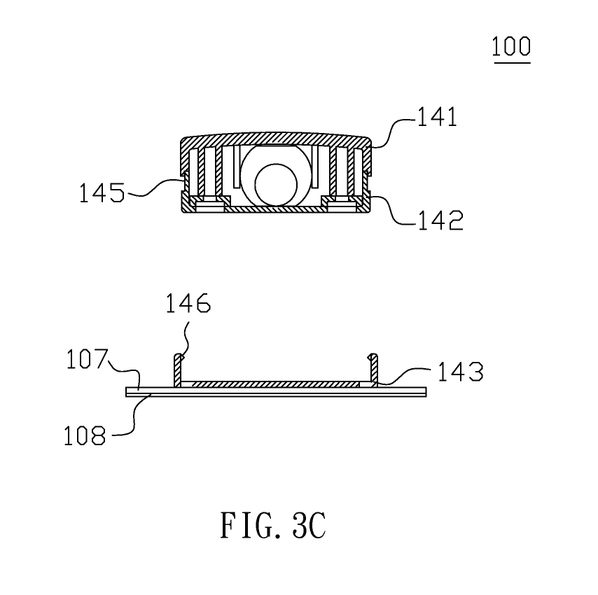

FIG. 3A is a top view showing an internal structure of a vibrating device of a vibrating massage apparatus according to an embodiment of the invention. FIG. 3B is a cross-sectional view showing a side of a vibrating device of a vibrating massage apparatus according to an embodiment of the invention. Referring to FIGS. 3A and 3B, the vibrating device 100 comprises a housing 104, a vibrator 110 and a patch 107. The vibrator 110 is disposed in the housing 104, the housing 104 fixes the vibrator 110 through a fixing structure, and the patch 107 is pasted on the lower side of the housing 104. The vibrator 110 is electrically connected to the signal output line 230.

In use, the user can paste the patch 107 on the skin surface of the ached portion, and operate the control device 200 so that the control device 200 can control, through the signal output line 230, the vibrator 110 to vibrate according to the control signal. Preferably, the patch 107 comprises an adhesive silica gel 108, which may be pasted on the skin.

In one embodiment, the vibrator 110 comprises a motor 111 and an eccentric wheel 112. The eccentric wheel 112 is connected to a motor shaft 113 of the motor 111. When the motor 111 is rotating, the center particle of the eccentric wheel 112 is not disposed on the axis of the core of the motor 111, so that the motor 111 is in a state where equilibrium continuously losses, and vibration is caused by inertia. In addition, as shown in FIG. 3A, in order to enhance the vibration transmission effect, the long axis direction of the motor shaft 113 of the motor 111 is parallel to the surface of the patch 107, and the upper and lower sides of the motor 111 are in contact with upper and lower surfaces of the inner wall of the housing 104. In addition, the eccentric wheel 112 is in contact with the lower surface of the inner wall of the housing 104 to enhance the vibration transmission effect. In one embodiment, only the lower side of the motor 111 is in contact with the lower surface of the inner wall of the housing 104 to enhance the vibration transmission effect.

As shown in FIG. 3C, the housing 104 in one embodiment comprises an upper casing 141, a lower casing 142 and a socket 143. The lower casing 142 is combined with the upper casing 141 to define a chamber for accommodating the vibrator 110. After the upper casing 141 and the lower casing 142 are combined together, a limit structure 145 is formed on the outer side of the combined upper and lower casings at a position near the interface between the upper and lower casings. In FIG. 3C, the limit structure 145 is a groove. The socket 143 has a lower surface to be attached to the patch 107, and has at least one hook portion 146 for hooking the limit structure 145. The limit structure 145 and the hook portion 146 are designed such that the socket 143 can be simply disassembled and assembled. When the patch 107 does not have the adhesive property any more, only the socket 143 needs to be replaced.

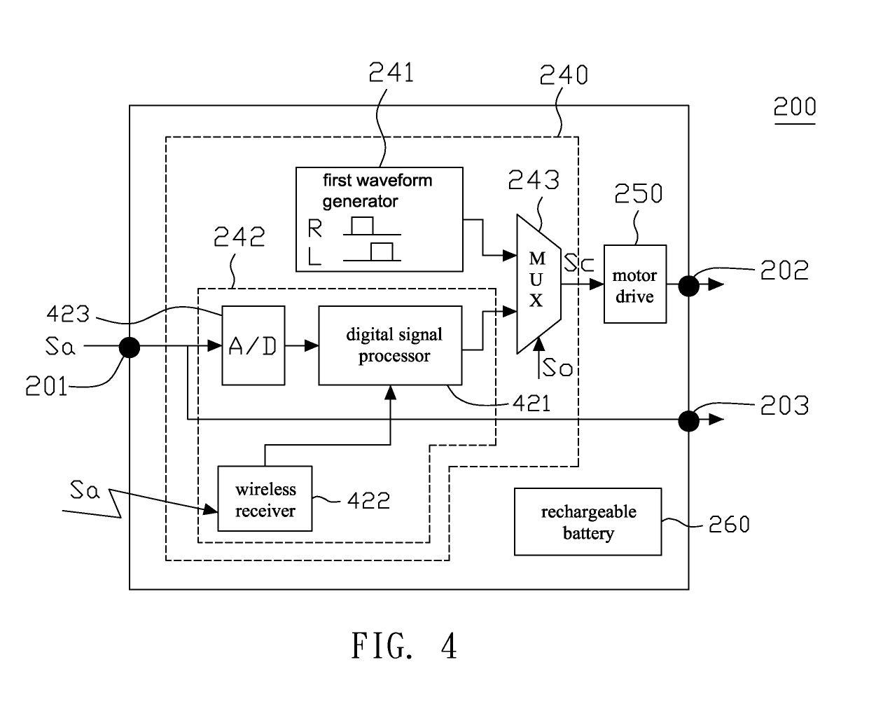

FIG. 4 is a functional block diagram showing the control device according to an embodiment of the invention. Referring to FIG. 4, the control device 200 comprises a waveform generator module 240 and a motor drive 250. The waveform generator module 240 outputs a control signal Sc having a waveform to the motor drive 250, and the motor drive 250 drives the vibrator 110 to vibrate in correspondence with the waveform through the signal output terminal 203 and the signal output line 230. In one embodiment, the waveform generator module 240 may comprise a first waveform generator 241 capable of generating a predetermined waveform. In another embodiment, the waveform generator module 240 comprises a second waveform generator 242, which receives an audio signal Sa and generates a control signal Sc having the waveform corresponding to the audio signal Sa according to at least one of rhythm and volume of the audio signal Sa. In another embodiment, the waveform generator module 240 can comprise a first waveform generator 241, a second waveform generator 242 and a multiplexer 243 concurrently. The first waveform generator 241 and the second waveform generator 242 are electrically connected to the motor drive 250 through the multiplexer 243, and the multiplexer 243 outputs the control signal Sc, generated by the second waveform generator 242 or the first waveform generator 241, according to a selection signal So.

In one embodiment, the second waveform generator 242 comprises a digital signal processor 421 and an analog-to-digital converter 423. The analog-to-digital converter 423 receives the audio signal Sa through the audio input terminal 201, converts the audio signal Sa into a digital signal, and then outputs the digital signal to the digital signal processor 421. The digital signal processor 421 generates the control signal Sc having the waveform corresponding to the audio signal Sa according to the digital audio signal Sa. In another embodiment, the second waveform generator 242 comprises a digital signal processor 421 and a wireless receiver 422. The wireless receiver 422 receives the audio signal Sa through radio waves, and then outputs the audio signal Sa to the digital signal processor 421. The digital signal processor 421 generates the control signal Sc, having the waveform corresponding to the audio signal Sa, according to the digital audio signal Sa. In this invention, the type of the wireless receiver 422 is not restricted, and may be a Wifi or Bluetooth wireless device.

In addition, the audio signal can generally comprise a left channel and a right channel, wherein an audio signal Sa may have a waveform corresponding to the left channel, and a waveform corresponding to the right channel. Thus, the number of the vibrating devices 100 is preferably equal to 2. When the user is listening to the music, the users mood changes with the change of the music. At this time, one vibrating device 100 may be used to sense the vibration of the sound corresponding to the left channel, and the other vibrating device 100 may be used to sense the vibration of the sound corresponding to the right channel. Thus, when the vibrating massage apparatus 300 of the invention is used, the rhythm of the music can be felt; and the sense of touch also feels the rhythm of the music, so that the users mood becomes more pleased, and the mental pain caused by the ache is also eased.

In one embodiment, the control device 200 may further comprise a rechargeable battery 260 for providing electric power to each electronic element of the control device 200. In addition, the vibrating massage apparatus 300 may also comprise a tie or a fastener tape to be tied on the arm or leg. Also, one vibrating device 100 may also comprise multiple vibrators 110, and the shape of the vibrating device 100 is not restricted, so that the vibrating device 100 is adapted for the massage apparatus for the shoulder, neck, back, waist, buttock, leg and the like.

In one embodiment, the vibrating massage apparatus 300 may be a massage cushion having multiple vibrators 110 in one cushion, and the control device 200 may control the vibrators 110 in the cushion to vibrate; or control the vibrators 110 to vibrate with the music.

In one embodiment, the control device 200 may be a Bluetooth headset. In addition, the control device 200 and the vibrating device 100 shown in FIG. 2 are separated, and electrically connected to each other through the signal output line 230. However, the invention is not restricted thereto. In one embodiment, the control device 200 may also be directly disposed in the housing 104, and more preferably, the control device 200 and the vibrating device 100 may also be one portion of a Bluetooth headset module to serve as expended functions of the Bluetooth headset. In addition, the limit structure 145 is formed on the housing of the Bluetooth headset. When the Bluetooth headset is to function as the vibrating massage apparatus 300, it is only necessary to assemble the socket 143 with the limit structure 145 of the housing of the Bluetooth headset to form the vibrating massage apparatus 300. When the massage function needs to be used, the Bluetooth headset of the assembled vibrating massage apparatus 300 may be pasted on the ached skin surface, and then connected to a mobile device or a music broadcaster in a wireless manner, and then the music is broadcasted through the mobile device or the music broadcaster so that the massage function can be performed. According to such design, the Bluetooth headset may be used with the socket being removed, and the socket may be equipped when only the massage function needs to be performed.

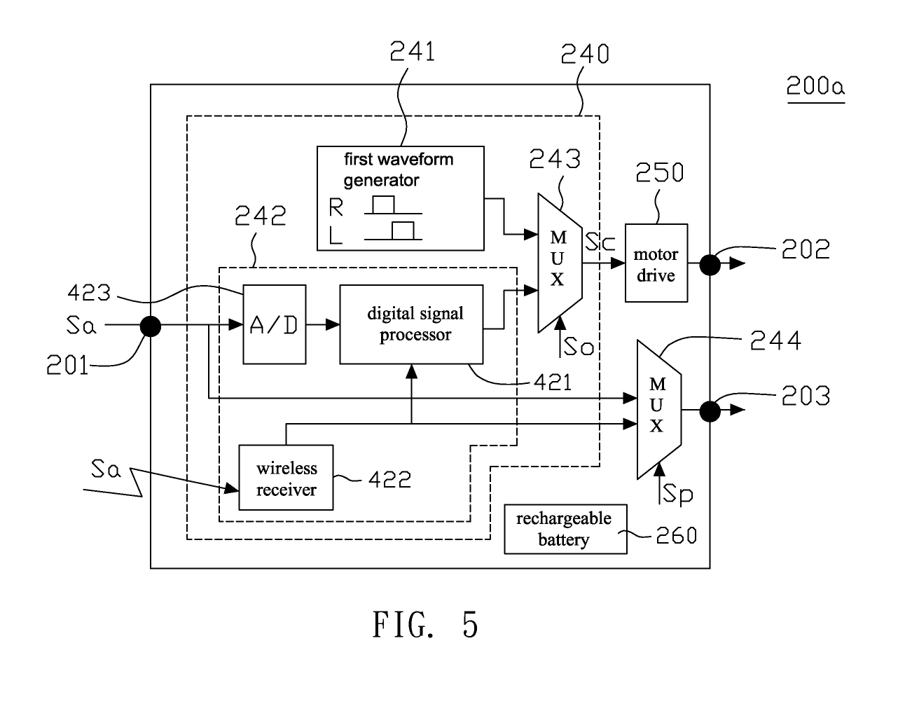

The Bluetooth headset with the vibrating massage apparatus will be described more specifically in the following. FIG. 5 is a functional block diagram showing a Bluetooth headset having the vibrating massage apparatus according to an embodiment of the invention. The Bluetooth headset 200a of FIG. 5 having the vibrating massage apparatus is substantially the same as the control device 200 of FIG. 4, so the same symbols denote the same elements, and associated descriptions thereof will be omitted. In FIG. 5, the Bluetooth headset 200a having the vibrating massage apparatus further comprises another multiplexer 244, and the audio input terminal 201 and the wireless receiver 422 are connected to the audio output terminal 202 through the multiplexer 244. The Bluetooth headset 200a having the vibrating massage apparatus controls the multiplexer 244 through another selection signal Sp, so that the multiplexer 244 outputs the audio signal Sa, coming from the audio input terminal 201 or the wireless receiver 422, to the audio output terminal 202, and the audio can be broadcasted through the microphone or the speaker (not shown).

According to the embodiment of the invention, a vibrating massage apparatus that can be easily carried is provided. Compared with the conventional vibrating massage apparatus, the vibrating massage apparatus of the invention is small in size and can be easily carried. In addition, in order to overcome the problem of the poor vibration effect or the poor vibration transmission effect caused by the small size, the patch 107 of the invention is pasted on the housing 104 of the vibrator 110, and the adhesive silica gel 108 of the patch 107 is used to paste the vibrator 110 on the skin surface so that the vibrator 110 closely rests against the skin surface to enhance the vibration effect or the vibration transmission effect. Furthermore, because the characteristic of the patch can continuously make the vibrator 110 closely rest against the skin surface, the trouble that the user needs to continuously hold the mechanical massage apparatus by the hand can be avoided. In addition, compared with the conventional current-type massager, the invention can avoid the problem of the muscle shrinkage and the problem that the massager cannot be used for a long time.

What is claimed is:

1. A vibrating massage apparatus to be pasted on a skin surface, the vibrating massage apparatus comprising:
a control device, comprising:
a waveform generator module for outputting a control signal having a waveform; and
a motor drive for receiving the control signal; and
at least one vibrating device, comprising:
a housing;
a vibrator disposed in the housing and electrically connected to the motor drive, wherein the motor drive controls the vibrator to vibrate in correspondence with the waveform according to the control signal; and
a patch having one side pasted on a surface of the housing, and the other side pasted on the skin surface.

2. The apparatus according to claim 1, wherein:
the vibrator comprises a motor and an eccentric wheel, and the eccentric wheel is connected to a motor shaft of the motor; and
when the motor rotates, a particle of the eccentric wheel is not disposed on an axis of the motor shaft, so that the motor is in a state where equilibrium continuously losses, and vibration is caused by inertia.

3. The apparatus according to claim 2, wherein a long axis direction of the motor shaft of the motor is parallel to a surface of the patch.

4. The apparatus according to claim 3, wherein a lower side of the motor is in contact with a lower surface of an inner wall of the housing to enhance a vibration transmission effect.

5. The apparatus according to claim 1, wherein the housing comprises:
an upper casing;
a lower casing, wherein the lower casing and the upper casing are combined together to form a chamber for accommodating the vibrator within the combined lower and upper casings, and to form a limit structure on an outer side of the combined lower and upper casings; and
a socket having a lower surface to be attached to the patch, and at least one hook portion for hooking the limit structure.

6. The apparatus according to claim 1, further comprising a signal output line connected to and between the control device and the at least one vibrating device.

7. The apparatus according to claim 1, wherein the control device is disposed in the housing of the at least one vibrating device.

8. The apparatus according to claim 1, wherein the waveform generator module comprises:
a first waveform generator for generating the waveform having a predetermined waveform, and outputting the control signal having the predetermined waveform;
a second waveform generator for receiving an audio signal, generating the waveform corresponding to the audio signal according to at least one of rhythm and volume of the audio signal, and outputting the control signal having the waveform corresponding to the audio signal; and
a multiplexer for outputting the control signal of the first waveform generator or the second waveform generator according to a selection signal.

9. The apparatus according to claim 8, wherein the second waveform generator comprises:
an analog-to-digital converter receiving the audio signal and converting the audio signal into a digital audio signal; and
a digital signal processor receiving the digital audio signal and generating the control signal having the waveform corresponding to the audio signal.

10. The apparatus according to claim 8, wherein the second waveform generator comprises:
a wireless receiver receiving the audio signal through radio waves; and
a digital signal processor receiving the audio signal and generating the control signal having the waveform corresponding to the audio signal.

11. A Bluetooth headset for broadcasting an audio signal, the Bluetooth headset comprising:
the vibrating massage apparatus according to any one of claims 1 to 7; and
a wireless receiver receiving the audio signal through radio waves, and outputting the audio signal to an audio output terminal,
wherein the waveform generator module generates the waveform corresponding to the audio signal according to at least one of rhythm and volume of the audio signal, and outputs the control signal having the waveform corresponding to the audio signal.
